(19) United States
(12) Patent Application Publication
(10) Pub. No.: US 2009/0294051 A1
(43) Pub. Date: Dec. 3, 2009

(54) OPTICAL CONTACTING ENABLED BY THIN FILM DIELECTRIC INTERFACE

(75) Inventors: Nick Traggis, Boulder, CO (US); Neil R. Claussen, Longmont, CO (US); Ove Lyngnes, Louisville, CO (US); Christopher J. Myatt, Boulder, CO (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: Precision Photonics Corporation, Boulder, CO (US)

(21) Appl. No.: 12/432,485

(22) Filed: Apr. 29, 2009

Related U.S. Application Data
(63) Continuation-in-part of application No. 12/263,806, filed on Nov. 3, 2008.
(60) Provisional application No. 61/057,541, filed on May 30, 2008.

(51) Int. Cl. B32B 37/02

(52) U.S. Cl. 156/275.5; 156/60; 156/308.2

(57) ABSTRACT

A method of assembling precision optical or optomechanical components of otherwise incompatible chemistry that provides first and second components having respective first and second polished contacting surfaces to be bonded; deposits a thin film dielectric coating at the surface of the first and or second polished surface, and contacts the coated portion of the first or second components with the respective contacting surfaces to be bonded, while maintaining alignment of the two components, to form a single structure.

### CROSS-REFERENCE TO RELATED APPLICATION(S)

This application is a continuation-in-part of U.S. application Ser. No. 12/263,806 filed on Nov. 3, 2008 and entitled OPTICAL CONTACTING ENABLED BY THIN FILM DIELECTRIC INTERFACE, which claims the benefit of U.S. Provisional Application No. 61/057,541, filed May 30, 2008 and entitled OPTICAL CONTACTING ENABLED BY THIN FILM DIELECTRIC INTERFACE, both of which are incorporated herein by reference.

### BACKGROUND OF THE INVENTION

The bonding of materials is critical in making high performance instruments or devices. Depending on the particular application, the quality of a bonding method is judged on criteria such as bonding precision, mechanical strength, optical properties, thermal properties, chemical properties, and the simplicity of the bonding process. Three popular bonding methods of the prior art are optical contacting, epoxy bonding, and high temperature frit bonding. The salient features of each of these three prior art methods are summarized below.

Optical contacting is a room temperature process which employs no bonding material, and is thus suitable only for certain precision applications involving surfaces having reasonably good surface figure match. Ideally, if the bonding surfaces are thoroughly cleaned prior to bonding, the resulting interface will have low thermal noise and contain almost nothing susceptible to oxidation, photolysis, and/or pyrolysis. However, due to its sensitivity to surface particulate and chemical contamination (such as by air-borne contaminants) and other environmental factors (such as humidity), optical contacting produces bonds which are generally unreliable in strength. In addition, surface figure mismatch almost always exists to some extent. Consequently, strong chemical bonds rarely occur extensively across the interface, and voids are sometimes seen in the interface. Bonds produced by optical contacting do not consistently survive thermal shocks. Typically, optical contacting has a low first-try success rate. In case of failure, de-bonding usually degrades surface quality, and thus lowers success rate in re-bonding.

Epoxy bonding is usually a room temperature process and has a good success rate for regular room temperature applications. However, because epoxy bonding is typically organic based, the bonding is susceptible to pyrolysis (such as by high intensity lasers) or photolysis (such as by ultra-violet light) in high power density applications, or both. The strength of the epoxy bond varies with temperature and chemical environment. Because the resulting wedge and thickness cannot always be precisely controlled, epoxy bonding is unsuitable for certain precision structural work. Epoxy bonding creates a relatively thick interface which makes optical index matching more of a concern in optical applications.

Frit bonding is a high-temperature process which creates a high-temperature rated interface. The interface is mechanically strong and chemically resistant in most applications. Because the frit material is physically thick and thus thermally noisy, it is unsuitable for precision structural work. For example, when optimized for bonding fused silica, frit bonding usually creates good coefficient of thermal expansion (CTE) matching with the bonded substrates at room temperature. The matching usually does not hold to a wider temperature range, however, resulting in strain and stress at or near the interface. Furthermore, a frit bond is opaque and inapplicable in transmission optics. Due to its high temperature requirement, frit bonding requires high temperature rated fixturing for alignment, and is thus expensive. Frit bonding is unsuitable if high temperature side effects, such as changes in the physical or chemical properties of the substrates, are of concern. Thus, each of the above prior art bonding methods has limitations and disadvantages.

More recently, other non-epoxy bonding methods have been introduced including the use of a hydroxide ion based bonding layer as described in U.S. Pat. Nos. 6,548,176 and 6,284,085 to Gwo that are both incorporated herein by reference, and the use of a thermal anneal assisted optical contacting device as described in U.S. Pat. No. 5,846,638 to Meissner and incorporated herein by reference. These two processes start to address some of the limitations of the standard optical contacting process described above, but also have their own drawbacks that this invention addresses.

### SUMMARY OF THE INVENTION

This is a method of assembling precision optical or optomechanical components of otherwise incompatible chemistry that provides first and second components having respective first and second polished contacting surfaces to be bonded; deposits a thin film dielectric coating at the surface of the first and or second polished surface, and contacts the coated portion of the first or second components with the respective contacting surfaces to be bonded, while maintaining alignment of the two components, to form a single structure.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is an electronic image of a laser cavity made up of a ULE spacer and ZnSe mirrors prepared with the method of the present invention.

FIG. 2 is an electronic image of a composite wave guide structure prepared with the method of the present invention.

FIG. 3 is a line drawing illustrating a beamsplitter to waveplate assembly made using the method of the present invention.

### DETAILED DESCRIPTION

This is a method of assembling precision optical or optomechanical components of otherwise incompatible chemistry that provides first and second components having respective first and second polished contacting surfaces to be bonded; deposits a thin film dielectric coating at the surface of the first and or second polished surface, and contacts the coated portion of the first or second components with the respective contacting surfaces to be bonded, while maintaining alignment of the two components, to form a single structure.

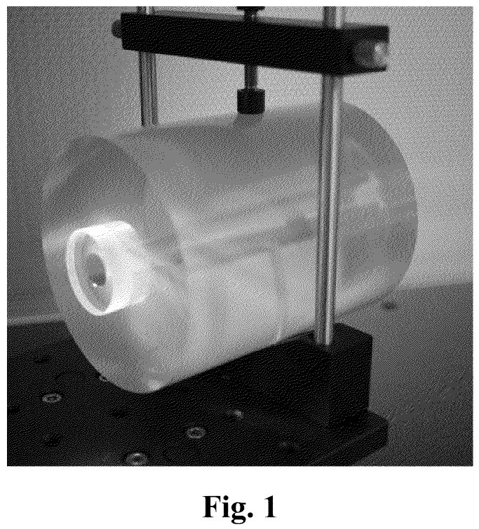

The present invention, in one embodiment, can be used to produce a precision laser cavity assembly made up of a ULE spacer and ZnSe mirrors as illustrated in FIG. 1. The surfaces of the ULE spacer and the ZnSe mirrors are polished to an optical quality polish on both sides, coated with 5 nm of Al₂O₃ on the polished ZnSe surfaces using ion beam sputtering, and annealed at 300° C. for 3 hours. The coated parts are brought into contact and annealed at 250° C. for 8 hours to improve bond strength. The ZnSe windows may then be coated for cavity performance as desired. Advantages of this process over the current state of the art include, in part, the following.
1) Eliminating epoxy to allow for better transmitted wave front variation and mechanical tolerances. No wedge is induced by the bond line.
2) Eliminating epoxy to allow for prevention of out-gassing of materials in a vacuum or high temperature environment.
3) The thin coating enables an epoxy free bond that would not be possible with conventional optical contacting because the ZnSe does not have available oxides for bonding in its normal state.
4) The 5 nm coating is thin enough to not affect optical performance in any substantial manner.

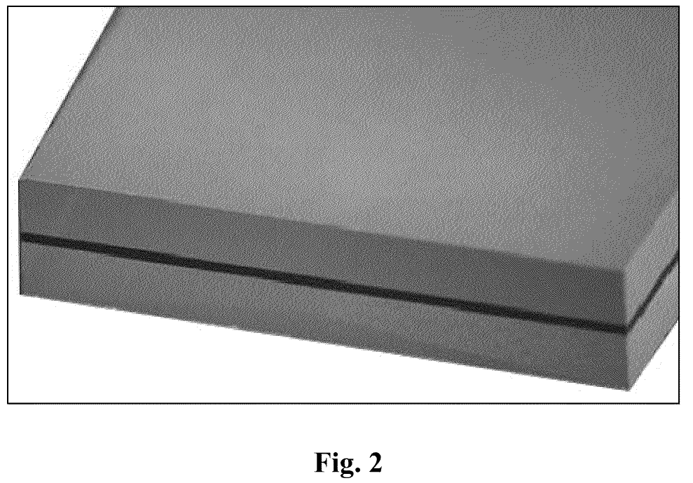

The present invention, in another embodiment, allows construction of composite structures used as amplifier and oscillator assemblies in solid state pumped laser systems as illustrated in FIG. 2. For example, this may include an Yb:YAG core with sapphire cladding on each side. This may also be a laser rod or slab assembly where undoped or doped material is bonded to the ends of the rod or slab, or in a disk laser assembly where the laser is mounted on cladding on only one side. The cladding may be of undoped or doped material and may be arranged in numerous form factors and configurations depending on the desired performance and application. The cladding can act in a number of ways to improve laser action: it can act as a heat spreader, a quencher of parasitic oscillation, as mechanical support for mounting or handling, and as a low index cladding for light guiding. The slabs are polished on the broad faces to an optical quality polish and cleaned using acetone and deionized water. A dielectric of 1.5 um of Al₂O₃ is applied to each surface of the cladding and gain media to be bonded to form a resultant 3 um thick bond interface. This coating is applied with an ion beam sputtering process to improve its durability. The coatings are annealed at 400° C. for 3 hours before bonding. In this embodiment, a bonding agent is prepared as 5% potassium hydroxide w/v in isopropyl alcohol and the slabs are immersed in the bonding agent for 5 minutes. The parts are then cleaned using a spin cleaning process and rinsed with deionized water. They are spun until dry. The parts are then brought into contact and bonded to form a sandwich type assembly. They are then annealed for 300° C. for 8 hours to improve bond strength. This provides adequate strength with no void formation. The end faces may then be polished or coated as necessary depending on the laser design. Advantages over the current state of the art include, in part, the following.
1) Creating a structure as illustrated with no epoxy or adhesive residue.
2) Eliminating epoxy to allow for better transmitted wave front variation and mechanical tolerances. No wedge induced by the bond line. This is especially important in the fabrication of devices with tight tolerances on the active layer thickness as one can reference against the bond when polishing a second layer with no risk of mechanical error additions during polishing.
3) Eliminating epoxy to allow for prevention of out-gassing of materials in a vacuum or high temperature environment.
4) Using coated interfaces as a way to contain the evanescent wave in the device and to tailor the index of this coating for changing the wave guiding properties.
5) Using coated interfaces as a way to help match the CTE of two dissimilar materials as in the case of YAG to sapphire. This allows the device to function over a wider temperature range without inducing unwanted stress.
6) Using the coated interface as a “diffusion layer” to help trapped gasses escape that may otherwise form voids during annealing of the bond to increase strength.

Another example of the process of the present invention includes bonding two silicon wafers (1″ diameter silicon wafers that are ¼″ thick) that are polished on one side to a flatness of less than 0.100 um deviation across the surface with a surface roughness of approximately 12 angstroms rms. Surfaces that are not as flat could be used, but this illustrated flatness level is a standard industry laser quality polishing level. The current invention has been demonstrated to be successful on parts with roughness values up to 75 angstroms rms. Parts with flatness over 6 um out of flat have also been bonded when their aspect ratio is such that they are conformal to each other (i.e., thinner parts don't have to be as flat as thicker parts for the process to work). The parts are brought into a clean room environment (Class 1000) and are cleaned and dried with isopropyl alcohol (IPA), acetone, and de-ionized water.

The parts are then coated with an ion beam sputtering deposition process with 5 nm of SiO₂ on each surface to be bonded. This provides a dielectric material interface to ensure compatible bonding chemistry. The parts are then annealed at 250° C. in order to relieve any coating stress and to ensure any residues are out-gassed before bonding.

The parts are then immersed into a solution of 5% potassium hydroxide in an isopropyl alcohol solvent for five minutes. The parts are removed from the solution and rinsed with deionized water or alkyl alcohols such as isopropyl alcohol and spun dry. (This removes any of the salt solution and prevents etching or staining of the coated surface.) The parts are then aligned and brought into contact with minimal pressure. The surfaces which are now quite hydrophilic will likely have a thin layer of water (monolayers) on them that form hydrogen bonds across the interface and the parts will adhere together with a contact wave observed as this occurs over 100% of the surface in contact. The parts are then placed in an annealing oven and brought to a temperature of 200° C. for several hours before being cooled to room temperature. The annealing schedule can be adjusted in both time and temperature depending on the specific materials to be bonded and thermal exposure concerns, but should be less than the annealing temperature the parts are to be exposed to after coating. A part sitting at room temperature for an extended period of time will also yield the same result. The resultant dehydration that will occur at the bond interface will remove most of the water present and allow for O—Si—O bonds to occur across the bond interface on the now active silicate network on the bulk material surface. These bonds are very strong and result in a finished assembly with near bulk material strength. The polish quality and cleanliness of the bonding environment can be optimized to ensure full bond density and strength of the process.

In another embodiment of the invention, two pieces of ceramic material such as Alon, or Spinel are bonded in an edgewise manner, in order to form a larger window than can be currently grown in a single piece of these ceramic materials. These ceramic materials have fairly large grains, such that the surface roughness after polishing is in the range of about 50-150 angstroms rms. This will not allow a complete bond at an interface between two pieces. By depositing 5 um of a dielectric material such as Al₂O₃ on both interfaces and then polishing the interface surfaces to approximately 2 um, the surface roughness value after polishing is less than 5 angstroms rms, and allows making a complete bond. The Al₂O₃ can be replaced with another oxide that better matches the optical or material properties of either Alcon or Spinel and their respective coefficients of thermal expansion, depending on the operating needs of the application.

In still another embodiment of the invention, a disk laser (doped Yb:YAG) is bonded to a handling substrate (such as SiC, Sapphire, undoped YAG, etc.). Due to the coefficient of thermal expansion (CTE) mismatch between these two materials it is likely that voids may form at the bond interface during elevated operating temperatures. In order to prevent an optical loss or etalon effect from such voids, an antireflective coating can be applied to both surfaces so that the resultant air gap does not cause refraction of the light passing through the interface.

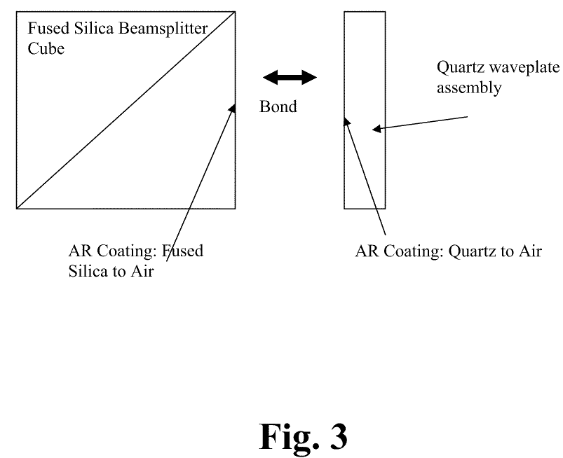

Another embodiment of this invention is bonding a quartz or sapphire waveplate onto a beamsplitter, laser rod, or other optical element made of a material such as YAG, fused silica, BK-7, or other related materials. Because the quartz has a different CTE than the material it is being bonded to, it is likely that voids may form at the bond interface during elevated operating temperatures. In order to prevent an optical loss or etalon effect from this void just, and antireflective coating (AR coating) may be applied to both surfaces such that the resultant air gap does not cause refraction of the light passing through the interface. This embodiment is illustrated in FIG. 3.

The invention as described above could make use of many deposition methods for the thin film dielectric. These include, but are not limited to: ion assisted evaporation, ion beam sputtering, ion plating, and magnetron sputtering. Coating materials could be selected from a selection of dielectric materials such as Ta₂O₅, SiO₂, Al₂O₃, TiO₂, HfO₂, ZrO₂, SC₂O₃, Nb₂O₅, or Y₂O₃. Considerations should be made for matching CTE to the substrate material as well as index match to the substrate material, and transmission at operating wavelengths when selecting coating material. The coating thickness at the interface could be upwards of 20 um thick, but optical performance should be considered. In most cases where no other optical performance is being considered, a 5-10 nm bond thickness should be sufficient. The purpose is to deposit a thin layer that is robust enough to be handled and bonded to without affecting final bond integrity or adhesion.

The invention as described above lends itself well to most oxide and non-oxide based materials such as natural quartz, fused quartz, fused silica, ultra low thermal expansion glass, borosilicate, BK-7 glass, SF series of glasses, sapphire, and doped or undoped phosphate glasses, nonlinear crystals, silicon, germanium, GaAs, ZnSe, ZnS, MgF₂, other fluorides, and ferroelectric materials and oxide based laser crystal materials.

Other materials that work well with the process are doped or undoped materials of ceramic or crystalline nature comprising Y₃Al₅O₁₂, Ca₂Al₂SiO₇, Gd₃Sc₂Al₃O₁₂, Y₃Sc₂Al₃O₁₂, CaY₄(SiO₄)₃O, Be₃Al₂Si₆O₁₈, Y_{3-X}Yb_{X}Al₅O₁₂, Nd_{X}Y_{1-X}Al₃(BO₃)₄, La_{1-X}Nd_{X}Mg_{X}Al_{12-X}O₁₉, Sr_{1-X}Nd_{X}Mg_{X}Al_{12-X}O₁₉, YAlO₃, BeAl₂O₄, Mg₂SiO₄, Y₃Fe₅O₁₂, Lu₃Al₅O₁₂, Al₂O₃, Y₂SiO₅ or CaCO₃. The lists above should be considered a guideline and not all-inclusive.

Bond density and consistency can be enhanced by a chemical activation to create a hydrophilic surface at the bond interfaces. The most straightforward way to do this is with a source of hydroxide ions such as found in solutions of calcium hydroxide, potassium hydroxide, sodium hydroxide, strontium hydroxide, sodium ethoxide, ammonium hydroxide, or potassium ethoxide dissolved in an organic solvent. Both aqueous and non-aqueous solutions may be used, however it is preferred to use a non-aqueous solution as too much water being present could potentially prevent full dehydration of the bond interface and result in void formation due to volatilized water vapor. Suitable solvents include both methanol and isopropanol.

Other non-liquid forms of surface activation have been demonstrated such as using a reactive ion plasma, or UV ozone. The goal of the chemical activation is to provide hydrophilic surfaces before the bonding process is initiated. It has also been demonstrated that polishing of the coated surfaces (leaving at least 90% of the coating material) using an aqueous slurry with a pH greater than 8 also results in a hydrophilic surface.

In some embodiments, one alternative includes cleaning the surfaces to be bonded, both before and after coating, to maximize bond density by eliminating any residue that could interfere with the process. Alternative methods that have been validated include solvent rinsing as described above, solvent touch-off, ultrasonic cleaning, ozone/hydrogen peroxide cleaning, deionized air cleaning, CO₂ snow cleaning, spin cleaning with a cleaning agent or solvent, UV-ozone cleaning, and RCA Clean cleaning.

The dehydration after contact is initiated is also an important step of the process. This will actually occur at room temperature in standard atmosphere if the assembly is left long enough, but in the interest of commercial viability, a faster more controlled method should be employed. This can be annealing in air or vacuum at a temperature below the glass transition temperature of the materials being bonded at temperatures in a range of about 0° C. to 1000° C., or other more exotic methods may be used such as UV or microwave exposure to dehydrate the bond. It is noted that the coating at the interface should be annealed before the bonding process is initiated in order to prevent shifting of stress or out-gassing that could compromise bond integrity.

A proper bond will generally exhibit the following characteristics including, in part, an interface that is transparent to wavelengths from deep UV to far infrared range, negligible optical loss (through absorption, scattering, or Fresnel reflections), or a high strength as a fraction of the bulk strength of the material.

Other embodiments using this process include assembling precision optical components comprising a lens, an optical flat, a prism, an optical filter element, a window, a wave plate, a diffraction grating, a laser slab assembly, a wave guide, an optical fiber, a laser crystal, an optomechanical spacer, a fixture, a polarizing element, and/or a mirror. More specific examples include a prism/etalon assembly used in wavelength locking, or a wave plate/beam splitter assembly used for polarization beam combining.

The current invention also allows for bonding of optical components with a thin film coating already present at the interface to be bonded. In order to allow for a robust coating that will withstand cleaning and handling, it is desired to use a coating process such as that deposited with an ion assisted evaporation, ion beam sputtering, ion plating, or magnetron sputtering. The existing thin film coating comprises a dielectric material offering optical performance such as an anti-reflection coating, partial refection coating, mirror coating, band pass or dichroic filter coating, polarization control, dispersion control, wave guiding, or light-trapping. The thin film interface coating can be deposited right on top of the existing coating in most cases.

In addition, the current invention allows for the dielectric material necessary for bonding to be integrated into the coating design of the desired or pre-existing coating needed for optical performance. The design of the new combined coating can be adjusted for the presence of the dielectric material desired at the bond interface without affecting total optical performance through the system. An example would be creating a 50% beamsplitter cube out of silicon. The coating at the interface between the two prisms would be designed to meet the required optical performance taking into account an additional 10 nm layer of SiO₂ on the outside facing the bond interface.

The present invention, allows bonding of non-oxide based materials such as Si, ZnSe, MgF₂, or other known non-oxide materials. This is not possible with the processes described under U.S. Pat. Nos. 5,846,638, 6,548,176, and 6,284,085.

The present invention allows for the epoxy free bonding of interfaces that have an optical thin film present. This is because the process does not leave a residue that can stain or etch the coatings, such as the processes described under U.S. Pat. Nos. 6,548,176 and 6,284,085. The high temperatures used in some of the prior art will also cause coating degradation due to the thermal expansion mismatch between the coating materials and the bulk substrate as potentially could occur under the process used in U.S. Pat. No. 5,846,638. The present invention does not require temperatures so high as to cause an issue here.

In addition, testing has shown that the dielectric materials in the coatings will form acceptable bond strength at lower temperature than the crystalline materials (YAG/sapphire) used in most laser assemblies. This is especially advantageous when dealing with composite assemblies that may have a poor CTE match, or parts that are already coated and thus cannot be annealed to a full annealing temperature.

The present invention allows the bonding of chemically sensitive materials such as phosphate glasses and doped phosphate glasses. This is because the thin film coating protects the material surfaces and the process does not leave a residue that can stain or etch the glass which would occur under processes described under U.S. Pat. Nos. 6,548,176 and 6,284,085. Phosphate glasses are often used in laser construction as they easily accept the dopants used as laser gain media.

The present invention allows the bonding of polished materials with higher surface roughness due to longer bond lengths enabled through the exposure to the bonding agent. Some of the prior art is limited to a surfaces with roughness better than 10 angstroms as indicated in the process reported in U.S. Pat. No. 5,846,638. In one embodiment, one can take a rougher surface, deposit the coating, then polish the coating down to a smoother surface to facilitate bonding not previously possible on the original surface(s). This has show great potential in ceramic materials where large grain variations make polishing the surface to an acceptable level difficult. The use of the described bonding agent also allows for better bond density and consistency of strength than the prior art.

The present invention results in bonds with very high mechanical shear strength. The strength is often limited only by the adhesion or integrity of the thin film interface. High energy deposition methods are typically utilized to optimize this. In some embodiments, an additional curing step in air or a vacuum at temperatures in a range of about 0° C. to 1000° C. may be used. In other embodiments, an additional curing step may be performed using a UV source or microwave radiation.

The present invention results in bonds that can withstand a very wide temperature range. YAG to YAG bonded laser slab assemblies have been produced that have been brought from room temperature to about 78 K (immersed in liquid N₂). These same bonds can also be heated from room temperature to 400° C. with no degradation of the bonding interface observed. It should be noted that coating materials need to be matched to the CTE of the substrate material to achieve optimum results. A smaller temperature range will be observed when bonding materials of different CTE.

The coated interface described in the present invention has been found to absorb some of the potential out-gassing that can occur when annealing post-bonding. This results in lower void formation, less stringent cleaning requirements than the processes described under U.S. Pat. Nos. 5,846,638, 6,548,176, and 6,284,085.

The present invention can be performed at room temperature in standard atmosphere by relatively unskilled personnel. A proper clean room environment is preferred for best performance.

The present invention offers a truly optically inert bonding interface. Negligible loss, scattering or index change has been observed in any of the applications or embodiments referenced herein, including those at UV wavelengths. It is noted that care must be taken to match the index of the dielectric material to that of the substrates to optimize performance.

The present invention has shown excellent long term stability and has passed accelerated aging tests from both the telecommunications and aerospace industries for deployed systems.

The coated interface in the present invention is thin enough to not deform the substrate, thus negating the need for the reported process under U.S. Pat. No. 5,724,185.

The present invention has been used in very high power laser systems exceeding 12J/cm² through the coated bond interface.

The present invention results in a hermetic seal that is both waterproof and resistant to standard solvents such as acetone, isopropyl alcohol, and methanol. Other chemical resistances are also expected.

Other applications that are embodiments of the present invention would include, in part, the following.

1) Assemblies making use of non-linear quasi phase matching processes such as alternating crystal orientations of GaAs bonded in a long array.

2) Assemblies where a thin optical element is bonded to a thicker element to improve its surface figure or flatness by conforming to the thicker element. Examples would include a true zero order quartz wave plate bonded to a thicker piece of BK-7, or a thin disk laser assembly such as 200 um of Yb:YAG bonded to a 2 mm piece of undoped YAG or sapphire. Post processing could even occur after bonding to bring the material to its final thickness.

3) Polarization beam-combiners can be formed by bonding a polarizing beam splitter as described above to a wave plate on one facet. The advantages using this process are higher damage threshold carrying capabilities, lower insertion loss, and lower transmitted wave front distortion due to zero bond line thickness.

4) Multi-element mirco-optic assemblies can also be created that allow for easier packaging and easier assembly. An etalon or other filter bonded to a beam splitter cube(s) is one such example. An example of this type of assembly is reported in U.S. Pat. No. 6,621,580.

5) Another multi-element micro-optic assembly would be a multi-element filter where several solid filter substrates are bonded together with optical coatings at the interface. This process allows for very tightly controller thickness matching and parallelism which would be required in such a transmission optic.

6) Air-spaced etalons can be formed where low expansion glasses such as Zerodur or ULE are bonded to transmissive mirror elements. This forms a cavity that is stable with temperature changes and gives great flexibility in the free spectral range and finesse of the cavity be tailoring the mirror reflectivity and spacer length.

7) Compound wave plate structures could be formed taking two pieces of quartz of different thickness and bonding them together with this process to achieve the desired optical retardation.

8) Precision mechanical assemblies that can take advantage of the near-zero bond-line thickness and resultant zero wedge also benefit from this process even when optical considerations are not important.

9) The present invention could also be used to mount an optical or mechanical assembly to a polished non-optical mount made of metal, plastic, ceramic, or glass. In this case the bonding allows mounting the optical elements to mounts such as heat spreaders or mechanical mounts.

10) Any optical or mechanical assembly that can benefit from lower absorption, higher fluence handling capabilities, near-zero bond line thickness, zero out-gassing, zero radiation susceptibility, and robust strength can benefit from this process.

Although the present invention has been described with reference to preferred embodiments, persons skilled in the art will recognize that changes may be made in form and detail without departing from the spirit and scope of the invention.

What is claimed is:

1. A method of assembling precision optical, mechanical, or optomechanical components comprising the steps of:
(a) providing first and second components having respective first and second polished contacting surfaces to be bonded;
(b) depositing a thin film dielectric coating at the surface of the first and or second polished surface; and
(c) contacting the coated portion of the first or second components with the respective contacting surfaces to be bonded, while maintaining alignment of the two components, to form a single structure

2. The method of claim 1, wherein the thin film dielectric coating is deposited with an ion assisted evaporation, ion beam sputtering, ion plating, or magnetron sputtering, deposition process.

3. The method of claim 1, wherein the thin film dielectric coating material is made up of oxide based materials such as: Ta₂O₅, SiO₂, Al₂O₃, TiO₂, HfO₂, ZrO₂, Sc₂O₃, Nb₂O₅, or Y₂O₃.

4. The method of claim 1, wherein the thin film dielectric coating material is between 1 and 20,000 nm thick.

5. The method of claim 1, comprising the additional steps of:
(d) generating a hydrophilic surface on at least a portion of at least one of the first or second surfaces; and
(e) rinsing the hydrophilic portion with water or another suitable solvent after the deposition of the coating in step (a).

6. The method of claim 5, wherein the rinsing further comprises rinsing away residue on at least a portion of the first or second surfaces.

7. The method of claim 1, wherein the first and second components are made from oxide based materials such as natural quartz, fused quartz, fused silica, ultra low thermal expansion glass, borosilicate glasses, crown glass, SF series of glasses, sapphire, doped or undoped phosphate glasses, nonlinear crystals, or oxide based laser crystal materials.

8. The method of claim 5, wherein the step of generating a hydrophilic surface on a portion of the first or second surfaces further comprises applying a bonding component to a portion of the first or second surfaces.

9. The method of claim 8, wherein the bonding component is rinsed off, or the surfaces to be bonded are cleaned after generating the hydrophilic surface.

10. The method of claim 8, wherein the bonding component comprises a source of hydroxide ions.

11. The method of claim 10, wherein the source of hydroxide ions comprises a non-aqueous source of hydroxide ions.

12. The method of claim 11, wherein the non-aqueous source of hydroxide ions comprises calcium hydroxide, potassium hydroxide, sodium hydroxide, strontium hydroxide, sodium ethoxide, ammonium hydroxide, or potassium ethoxide dissolved in an organic solvent.

13. The method of claim 12, wherein the organic solvent is methanol or isopropanol.

14. The method of claim 5, wherein the step of generating a hydrophilic surface on at least a portion of the first or second surfaces comprises polishing portions of the surface with an aqueous slurry having a pH greater than 8, and removing less than 90% of the existing coating.

15. The method of claim 8, wherein the bonding component comprises a non-liquid bonding component.

16. The method of claim 15, wherein the non-liquid bonding component comprises a reactive ion plasma, or UV ozone.

17. The method of claim 1, further comprising the step cleaning at least one of the first or second surfaces to be bonded before depositing the coating.

18. The method of claim 17, wherein the step of cleaning at least one of the first or second surfaces to be bonded includes at least one of solvent rinsing, solvent touch-off, ultrasonic cleaning, ozone/hydrogen peroxide cleaning, deionized air cleaning, CO₂ snow cleaning, spin cleaning with a cleaning agent or solvent, UV-ozone cleaning, or RCA Clean cleaning.

19. The method of claim 1, wherein at least one of the first and second surfaces is a doped or undoped materials or ceramic or crystalline nature comprising Y₃Al₅O₁₂, Ca₂Al₂SiO₇, Gd₃Sc₂Al₃O₁₂, Y₃Sc₂Al₃O₁₂, CaY₄(SiO₄)₃O, Be₃Al₂Si₆O₁₈, Y_{3-X}Yb_{X}Al₅O₁₂, Nd_{X}Y_{1-X}Al₃(BO₃)₄, La_{1-X}Nd_{X}Mg_{X}Al_{12-X}O₁₉, Sr_{1-X}Nd_{X}Mg_{X}Al_{12-X}O₁₉, YAlO₃, BeAl₂O₄, Mg₂SiO₄, Y₃Fe₅O₁₂, Lu₃Al₅O₁₂, Al₂O₃, Y₂SiO₅, or CaCO₃.

20. The method of claim 1, wherein the first or second surfaces are made up of non-oxide based materials such germanium, GaAs, silicon, ZnSe, ZnS, MgF₂, other fluorides, and ferroelectric materials.

21. The method of claim 1, wherein a final curing step is performed in air or vacuum at a temperature in the range of 0° C. up to 1000° C.

22. The method of claim 1, wherein the thin film coating is annealed in air at a temperature in the range of 0° C. up to 1000° C. prior to bonding.

23. The method of claim 1, wherein a final curing step is performed using a UV source or microwave radiation.

24. The method of claim 1, wherein the precision optical component comprises one or more lenses, an optical flat, a prism, an optical filter element, a window, a wave plate, a laser slab assembly, a wave guide, an optical fiber, a laser crystal, an optomechanical spacer, a fixture, a polarizing element, or a mirror.

25. The method of claim 1, wherein the contacting surfaces have a surface roughness of less than 75 angstroms.

26. The method of claim 1, wherein the surfaces to be bonded already have a thin film coating at the interface.

27. The method of claim 25, wherein the thin film coating is deposited with an ion assisted evaporation, ion beam sputtering, ion plating, or magnetron sputtering, deposition process.

28. The method of claim 26, wherein the thin film coating comprises a dielectric material offering optical performance such as an anti-reflection coating, partial refection coating, mirror coating, bandpass or dichroic filter coating, polarization control, dispersion control, waveguiding, or light-trapping.

29. The method of claim 25 wherein the dielectric material is integrated into an existing thin film coating.

30. The method of claim 25 wherein the existing coating is compatible with a subsequent dielectric layer.

31. The method of claim 1, wherein the thin film dielectric coating is polished before bonding to help reduce surface roughness and improve surface flatness resulting in greater bond strength and quality.

32. A method of assembling precision optical, mechanical, or optomechanical structures comprising the steps of:
(a) providing first and second components to be bonded having respective first and second contacting surfaces, wherein at least one of the contacting surfaces has a surface roughness of about 15-150 angstroms rms;
(b) depositing a thin film dielectric coating on at least the contacting surface having a surface roughness of about 15-150 angstroms rms to give a coated contacting surface;
(c) polishing the thin film dielectric coating on the coated contacting surface to a surface roughness of less than about 10 angstroms rms;
(d) generating a hydrophilic surface on at least one of contacting surface of the coated contacting surface; and
(e) contacting the contacting surface and the coated contacting surface, while maintaining alignment of the two components, to form a bonded structure.

33. The method of claim 32, wherein the first component comprises a large grain (>1 um) ceramic material.

34. The method of claim 32, wherein the second component comprises a large grain (>1 um) ceramic material.

35. The method of claim 34, wherein the first contacting surface comprises an edge surface of the first component and the second contacting surface comprises an edge surface of the second component.

36. The method of claim 32, wherein the thin film dielectric coating comprises a refractive index that substantially matches to a refractive index of at least one of the first component and the second component.

37. The method of claim 32, wherein the thin film dielectric coating comprises a coefficient of thermal expansion that substantially matches a coefficient of thermal expansion of at least one of the first component or the second component.

38. The method of claim 32, wherein depositing the thin film dielectric coating comprises depositing the thin film dielectric coating with an ion assisted evaporation deposition process, an ion beam sputtering deposition process, an ion plating deposition process or a magnetron sputtering deposition process.

39. The method of claim 32, wherein the thin film dielectric coating comprises Ta₂O₅, SiO₂, Al₂O₃, TiO₂, HfO₂, ZrO₂, Sc₂O₃, Nb₂O₅, or Y₂O₃.

40. The method of claim 32, further comprising cleaning at least one of the first or second contacting surfaces before depositing the thin film dielectric coating.

41. The method of claim 32, further comprising a curing step that is performed in air or vacuum at a temperature in the range of about 0° C. up to 1000° C.

42. The method of claim 32, further comprising a curing step that is performed using a UV source or microwave radiation.

43. The method of claim 32, further comprising an annealing step in which the thin film dielectric coating is annealed in air at a temperature in the range of about 0° C. up to 1000° C.

44. A method of assembling precision optical, mechanical, or optomechanical components comprising the steps of:
(a) providing first and second components having respective first and second contacting surfaces, wherein the first and second components have different coefficient of thermal expansion values;
(b) applying a first anti-reflective coating to the first contacting surface and applying a second anti-reflective coating to the second polished contacting surface, wherein the first and second anti-reflective coatings comprise a dielectric material;
(c) polishing the first and second anti-reflective coatings;
(d) generating a hydrophilic surface on at least one of the first and second surfaces; and
(e) contacting the first and second contacting surfaces, while maintaining alignment of the two components, to form a bonded assembly.

45. The method of claim 44 wherein the first and second components having respective first and second contacting surfaces, wherein the first and second components are under mechanical stress in their final form, or are otherwise likely to delaminate during use in their final application.

46. The method of claim 44 wherein the first and second components having respective first and second contacting surfaces, wherein the first, second, or both components have a pattern or other feature on them (such as a grating or polarizer wire grid) that would cause an air gap between the two surfaces after bonding.

47. The method of claim 44, wherein the anti-reflective coating is selected to operate at an interface between the bonded assembly and an liquid medium.

48. The method of claim 47, wherein the other medium comprises one or more of cooling water, liquid nitrogen, or another liquid in contact with the assembly.

49. The method of claim 44, wherein the anti-reflection coating materials are selected with consideration of matching the coefficient of thermal expansion of at least one of the first component or the second component.

50. The method of claim 44, wherein depositing the thin film dielectric coating comprises depositing the thin film dielectric coating with an ion assisted evaporation deposition process, an ion beam sputtering deposition process, an ion plating deposition process or a magnetron sputtering deposition process.

51. The method of claim 44, further comprising cleaning at least one of the first or second contacting surfaces before depositing the thin film dielectric coating.

52. The method of claim 44, further comprising a curing step that is performed in air or vacuum at a temperature in the range of about 0° C. up to 1000° C.

53. The method of claim 44, further comprising a curing step that is performed using a UV source or microwave radiation.

54. The method of claim 44, further comprising an annealing step in which the thin film dielectric coating is annealed in air at a temperature in the range of about 0° C. up to 1000° C.
